(19) United States
(12) Patent Application Publication
(10) Pub. No.: US 2012/0066017 A1
(43) Pub. Date: Mar. 15, 2012

(54) System and Method for Utilizing Industry Specific Competencies to Maximize Resource Utilization

(76) Inventor: Paul E. Siegel, Demarest, NJ (US)

(21) Appl. No.: 12/878,726

(22) Filed: Sep. 9, 2010

(51) Int. Cl. G06Q 10/00

(52) U.S. Cl. 705/7.14

(57) ABSTRACT

A computer-implemented method for identifying requirements associated with a job type and to matching personnel to the requirements including identifying any deficiencies in satisfying the requirements is described. The method includes identifying one or more of each of a knowledge requirement, a skill requirement, and a behavior requirement associated with a job type, generating and administering a competency identification test for the job type based on the requirements, generating a personnel profile based on the competency identification test, the personnel profile including at least a knowledge competency, a skill competency and a behavior competency, and generating a role analysis report including a correlation score indicating the determined correlation between the competencies and the requirements.

### BACKGROUND OF THE INVENTION

The present application is directed to a system and method for identifying and utilizing competencies and requirements in a resource allocation system and method. More particularly, the present application is directed to a system and method for quantifying competency requirements, skill requirements and behavior requirements associated with a job-type and for identifying and managing resources to satisfy the quantified requirements.

Matching people to specific jobs to maximize their productivity and satisfaction is one of the most difficult challenges facing companies and workers today. However, reducing turnover is one of the best ways for companies to retain valuable employees and their associated knowledge base. Similarly, employees are most satisfied doing jobs that match their personality, knowledge, and skill set. Identifying the right position for an employee maximizes value for both the employee and the company.

In practice, it is exceedingly difficult for managers to define, identify, and manage an ideal candidate for any particular job. Candidates are often selected based on their resume and personal interviews that may not demonstrate how well they would perform in a particular job. Accordingly, jobs are often filled based on hiring, succession, etc. without any way to assess the fit between the applicant and the job to be performed. Further, an employee that did or did not perform well in one organization or job may not have the same performance in a different job or even in the same job within a different company having different culture/expectations/etc.

Managers also face difficulty in defining the requirements for a job. Often jobs require soft skills, such as likability, conversation skills, salesmanship, etc. that are hard to define and quantify. Accordingly, job requirements are often defined solely on generic educational and training backgrounds. No attempt is made to identify and quantify the particular competencies that are used in the daily performance of the job.

Further, when a job is filled with an applicant that does not quite match the job, managers find it difficult to identify and address competency gaps. Also, transitioning workers and/or new applicants are often told they are either suitable or unsuitable for a job based on a list of requirements for that job without being informed about training that would allow them to obtain the competencies required for the job.

What is needed is a system and method for mapping industry specific competencies to job applicants and matching these competencies to job requirements to determine the correlation between the two. What is further needed is such a system and method configured to identify competency gaps and one or more programs to address those performance gaps.

### SUMMARY OF THE INVENTION

One exemplary embodiment of the invention includes a computer-implemented method for identifying requirements associated with a job type and for matching personnel to the requirements including identifying any deficiencies in satisfying the requirements. The method includes identifying one or more of each of a knowledge requirement, a skill requirement, and a behavior requirement associated with a job type, generating and administering a competency identification test for the job type based on the requirements, generating a personnel profile based on the competency identification test, the personnel profile including at least a knowledge competency, a skill competency and a behavior competency, and generating a role analysis report including a correlation score indicating the determined correlation between the competencies and the requirements.

Another exemplary embodiment of the invention includes a computer-implemented method for identifying one or more training workshops based on a correlation between job requirements and applicant proficiencies. The method includes determining a listing of competencies representing knowledge, skills, or behaviors for a company, the competencies including both industry specific competencies and company specific competencies. The method yet further includes determining a listing of requirements for one or more jobs in the company, the requirements including both industry requirements and company specific requirements and administering a competency identification test for at least one employee of the company. The results of the test may be used for generating an employee profile based on the competency identification test, the personnel profile including at least a knowledge competency, a skill competency and a behavior competency and identifying one or more jobs having requirements correlated to the competencies in the employee profile.

Another embodiment includes identifying one or more jobs where the competencies in the employee are deficient in satisfying the job requirements and generating a course listing based on the deficiency. Another includes providing a correlation score indicating the correlation between employee competencies and requirements for a plurality of the jobs in the company, the correlation score including a separate score for each identified requirement for each job.

Yet another embodiment includes having the correlation score include an aggregate score based on a determination of how many identified requirements are satisfied by the identified requirements, where the correlation score includes a color coded indication indicating the relative correlation between the requirements and the competencies.

These particular features and advantages may apply to only some embodiments falling within the claims and thus do not define the scope of the invention.

### BRIEF DESCRIPTION OF THE FIGURES

FIG. 1 is a computer-implemented system for identifying and utilizing competencies for job roles in assessing job applicants is shown, according to an exemplary embodiment;

FIG. 2 is an exemplary competency report illustrating an analysis of the suitability of an applicant, according to an exemplary embodiment;

FIG. 3 is the exemplary competency report of FIG. 2 with the development summary tab selected, according to an exemplary embodiment;

FIG. 4 is a selection of the workshops tab and/or e-learning tab of FIG. 2 configured to display a listing of available courses, wherein each of the courses has been analyzed to determine the competencies trained by that workshop, according to an exemplary embodiment;

FIG. 5 is a database representation illustrating the information storage and interconnection utilized by the systems of FIG. 1, according to an exemplary embodiment; and

FIG. 6 is a flowchart illustrating a method for implementing the system of FIG. 1, according to an exemplary embodiment.

### DETAILED DESCRIPTION OF THE PREFERRED EMBODIMENT

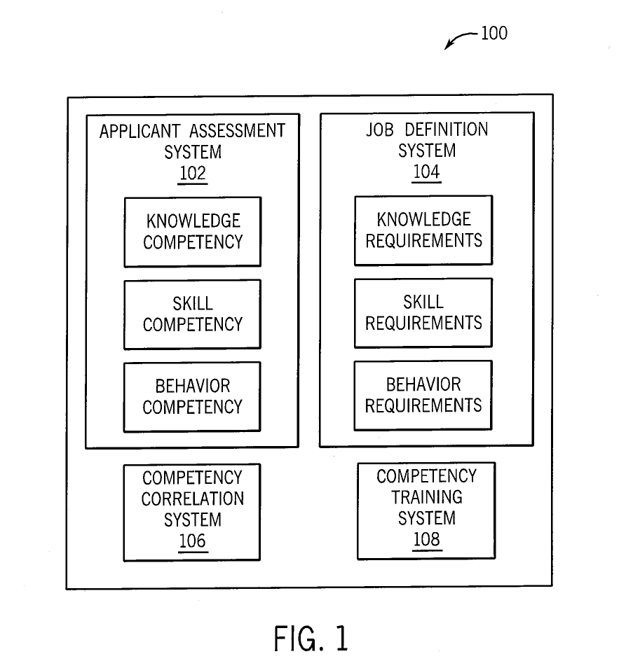

Referring first to FIG. 1, a computer-implemented system 100 for identifying and utilizing competencies for job roles in assessing job applicants is shown, according to an exemplary embodiment. System 100 includes an applicant assessment system 102, a job definition system 104, a competency correlation system 106, and a competency training system 108. Although system 100 is described herein with reference to an applicant, one of ordinary skill in the art would understand that that method and system described herein is equally useful for current employees to maximize their potential in their current role, employees seeking transfers, employees up for promotion, etc. System 100 may be utilized for identifying, structuring and utilizing one or more Bodies of Knowledge™ as industry sector tools for quantifying, storing, measuring, assessing and managing knowledge, skill and behavior requirements (called “competencies”) for job roles within that industry; for benchmarking competencies, roles, compensation and other metrics within and across companies; for analyzing job role fits for individuals to identify vertical and lateral career path opportunities; and for weighing, prioritizing and budgeting for education and training.

In order to competently match personnel to companies, companies must evaluate each job to be performed to determine the knowledge, skill set, and behaviors that are required or ideal for performing the job in question. Companies must further assess applicants, whether internal or external, to determine each applicant's ability to excel in that job. In other words, companies must correlate the knowledge, skill set, and behaviors that are required or ideal for performing the job with the knowledge, skill set, and behaviors that can be assessed for each applicant.

Applicant assessment system 102 may be a computing system configured to identify the competencies of a job applicant. A competency may be any quantifiable aspect related to a job applicant. Competency may quantified based on a variety of measure including, for example, a positive/negative scale describing whether an applicant has completed a specific training course, a range scale rating the applicant likeability on a scale of 1 to 10, etc. Applicant assessment system 102, although identifying competencies associated with the applicant, may be configured to particularly identify those skills identified within job definition system 104 and determined to be relevant by the organization implementing the system 100. For example, where system 100 is implemented in a financial service company, assessment center 102 may be configured to include assessments of competencies to identify skills associated with job roles defined by system 104 related to the financial services company, such as loan brokers, securities brokers, real estate managers, etc.

Assessments implemented by system 102 may include training, history reviews, self evaluation ratings, peer ratings, traditional examination-based testing, etc. Assessments may include both subjective assessments including, for example, self-evaluation, a manager evaluation of an employee, staff member evaluation of an employee, and/or 360° review and objective assessments including, for example, competency-based testing, aptitude testing, job specification based testing, etc.

Applicant assessment system 102 may also be configured to implement an assessment process for all current employees of an organization. Assessments may be performed to facilitate manager and team development using the assessments of employee competencies, job definitions, and correlations described herein to develop managers, improve communications and accountability, and measure progress. Assessments may be used to establish knowledge, skill, and behavioral benchmarks for current employees and/or potential hires.

Assessment system 102 may be configured to provide a competency assessment for an applicant including a listing of their overall knowledge competency including a number of knowledge based competency assessments, their skill competency including a number of skill based competency assessments, and their behavioral competency including a number of behavioral based competency assessments.

Generally, knowledge based competencies reflect an applicant's formal training. Knowledge based competencies can include courses completed, testing results, past experiences, etc. Skill based competencies reflect an applicant's abilities for compete specific tasks and can include work experience, testing results designed to test that skill, feedback based on skill demonstration, etc. Behavioral based competencies reflect an applicant's demonstrated behaviors and can include performance evaluations, self evaluations, personality testing, etc. It is important to recognize that any particular competency and any particular system or method for identifying that competency may belong in multiple classifications. System 100 may be configured to allow users to customize the listing of competencies, the systems and methods used to identify those competencies, etc.

Job definition system 104 may be a system configured to define jobs or roles based on a set of defined requirements. Accordingly a job may be defined by a list of defined requirements needed to perform that role in an organization. The defined requirements may be organized into three defined sets, including knowledge requirements, skill requirements, and behavior requirements. System 100 may be implemented such that knowledge requirements, skill requirements, and behavior requirements correlate, respectively, to knowledge, skill, and behavior competencies.

Defined requirement may be created for each job in an organization. The defined requirement may be defined based on industry standards, the results of a job analysis examining the tasks required to perform a job, company standards, etc. Defined requirement based on industry standards may also be supplemented or replaced based on requirements that are particular to a company.

Each defined requirement may be configured to include a level of proficiency rating associated with the requirement. The level of proficiency rating may be ratings, scores, pass/fail indications, etc. indicating the competency required by an individual to satisfy the job requirements. An exemplary level of proficiency rating may be provided, for example, based on a subjective self evaluation examination where the applicant is invited to select from a group of responses that he or she feels best represents his or her confidence in his or her ability to perform each of the job requirements listed for a particular job. According to an exemplary embodiment, applicants for a job may be required to demonstrate the defined levels of proficiency using system 102 prior to consideration as an applicant for a new position, promotion, lateral move, etc.

Competency correlation system 106 may be a system configured to correlate the competencies assessed by system 102 with the requirements defined by the job definition system 104 to determine a role analysis rating. The role analysis rating may provide an indication of the suitability of a particular applicant to perform the requirements associated with a particular job. Alternatively, the role analysis rating may include a ranking of a plurality of applicants or employees for performing the requirements associated with a particular job. The role analysis rating may also be used to identify and rank a plurality of jobs that an applicant or employee is particularly suited to perform.

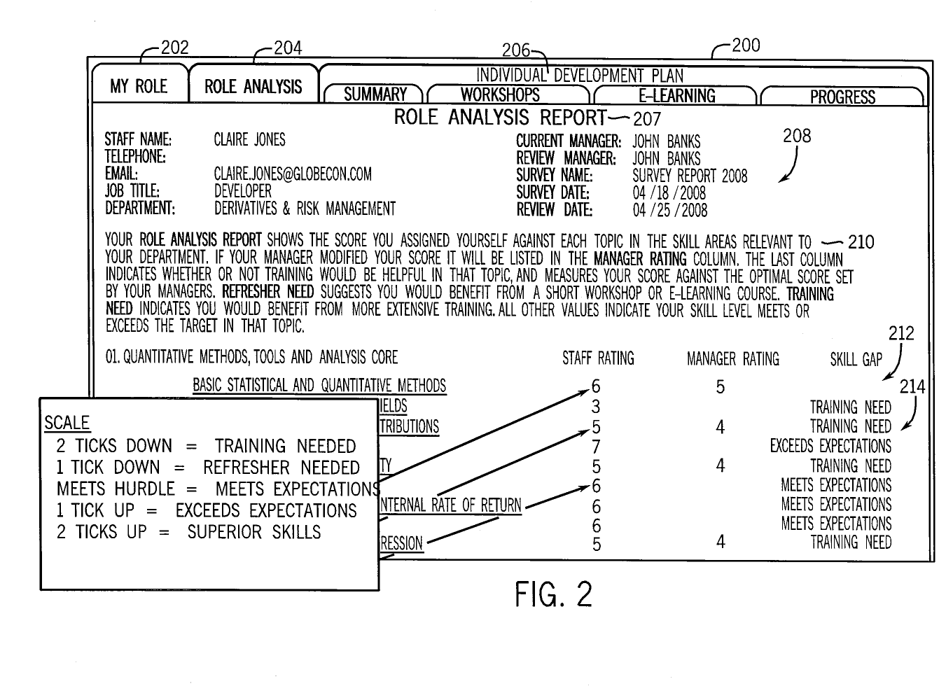

According to an exemplary embodiment, the role analysis provided by system 106 may be a detailed analysis of the competencies of an applicant relative to each requirement for the role. This analysis is described in further detail below with reference to FIG. 2.

Competency training system 108 may be a system for identifying one or more competency/requirement gaps in an applicant or employee's competencies based on the role analysis rating generated by system 106 and identifying one or more training courses to address the deficiency. For example, for an applicant applying for a particular job, competency training system 108 may be configured to generate a report listing the knowledge, skill, and behavior competencies required for a job and comparing those competencies with the applicants' assessed competencies.

Referring now to FIG. 2, an exemplary competency report 200 illustrating an analysis of the suitability of an applicant, Claire Jones, for a specific role as a developer in the derivatives and risk management department in a financial institution. Competency report 200 may be generated by system 108 based on combined inputs from systems 102-106. Competency report 200 may be configured to include a current role tab 202, a role analysis tab 204, and a development plan tab 206. Although a specific layout and configuration is shown and described herein, it should be understood that competency report 200 may be configured in a variety of ways and include a variety of different information to perform the functions described herein.

Current role tab 202 may be populated by applicant assessment system 102 based on the applicant's knowledge background, work history, received evaluations, testing results, etc. Role tab 202 may be configured to display the knowledge competency, the skill competency, and the behavioral competency of the applicant for that particular role. Each competency may be associated with multiple attributes, including at least a practice area, a level, a skill group, and a learning outcome statement clearly stating what is required to obtain the competency.

Each competency has one practice area assigned. Practice areas may be specifically defined categories including multiple competency that are specific to the industry being analyzed. For example, the practice area may be selected from the group of

TABLE 1

| | |
|---|---|
| 01 | Quantitative Methods, Tools and Analysis |
| 02 | Financial Analysis, Credit, Lending and Treasury |
| 03 | Corporate Finance |
| 04 | Portfolio and Investment Management |
| 05 | Equity Capital Markets and Investments |
| 06 | Debt Capital Markets and Fixed Income |
| 07 | Derivatives, Foreign Exchange & Risk Management |
| 08 | Alternative Investments, Real Estate, Hedge Funds and Private Equity |
| 09 | Wealth and Asset Management |
| 10 | Retail, Consumer and Individual Banking & Finance |
| 11 | Laws & Practice of Shari′a |
| 12 | Business, Qualitative, Behavioral and ‘Soft’ Skills |
| 13 | Legal, Regulatory and Compliance |
| 14 | Operations, Systems and Process |

Although Table 1 provides a listing of practices areas related to a role within a financial services company, it should be understood that the specific practice groups used will vary by industry.

A role analysis tab 204, when selected, is configured to provide a role analysis report 207 comparing the applicant's competencies to the requirements for a specific job. Report 207 is configured to include a header 208 describing the applicant and providing information indicative of contributors and/or sources of the information used to generate the report, an information message 210 describing the contents of the reports, and a competency reporting section 212. Although an exemplary configuration of report 200 including the results of a self evaluation and manager evaluation is shown, it should be understood that the report 207 may include a variety of competency assessment information as described herein.

According to an exemplary embodiment, system 100 may be configured to generate aggregate scores collected for groups of entities, such as each work team or managed group. These aggregate scores may be used where managers may be ranked and identified as to the overall competency of their work teams.

Competency reporting section 212 is configured to provide information indicating an applicant's current competency rating. According to an exemplary embodiment, this competency information may be shown by comparing the applicant's competencies to requirements for one or more jobs to provide a correlation score 214, indicating how closely the applicant's competencies correlate to the requirements of the job. The job may be a current role, a desired role, etc. Correlation score 214 can be any indication of the relation between the role requirements and applicant competencies. For example, score 214 as shown in FIG. 2 provides a descriptive score display using any means, such as a color coding using green or a particular shading as shown, indicating that the competencies are a good match to the requirements and further providing a descriptive entry describing whether the applicant meets the requirement, exceeds the requirements, etc. System 100 may be configured to allow users to identify one or more hurdle requirements where it is required that an applicant's competencies meet or exceed requirements.

System 100 may be further configured to generate an aggregate analysis score based on a defined scale 216. Scale 216 may generate an aggregate score using upward and downward movement along a scale related to the correlation between requirements and competencies.

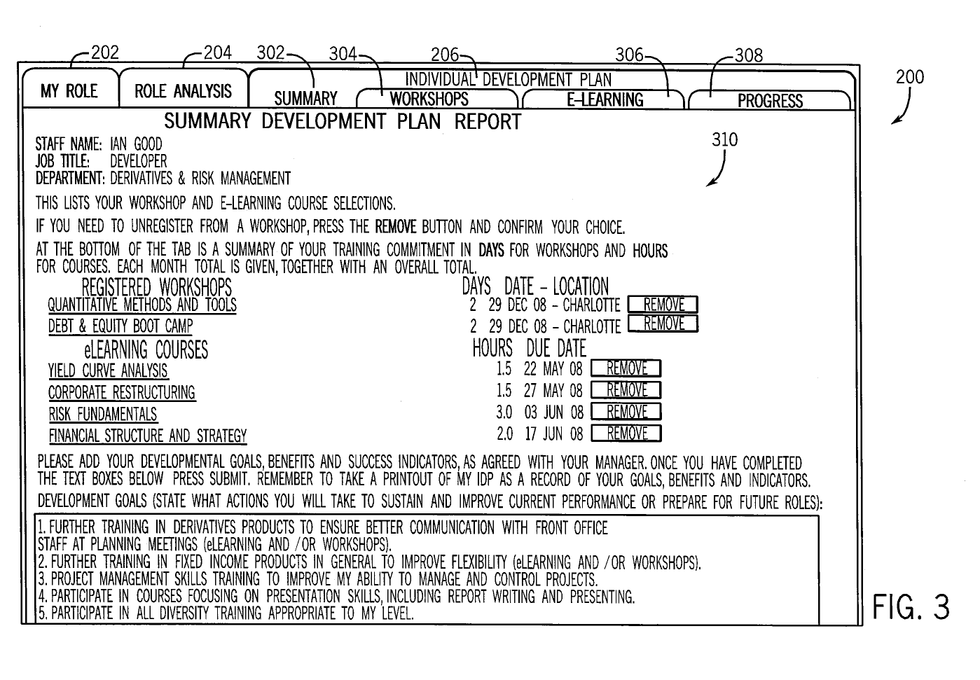

Based on the correlation scores 214 in report 207, system 108 may be configured to generate a development plan for the applicant to outline the steps training/development that can be performed for competencies identifies as requiring additional training, accessible through development plan tab 206. Referring now to FIG. 3, development tab plan 206 may be configured to include a summary tab 302, shown as selected in FIG. 3, a workshops tab 304, an e-learning tab 306, and a progress tab 308. The information provided under each of the tabs may be customized based on the results generated by competency correlation system 106 and competency training system 108.

Summary tab 302 may be configured, when selected, to display a summary development plan report 310. Report 310 may be configured to include a summary of information included in further detail under tabs 304-308, including a listing of workshops and e-learning courses for which the applicant has registered, a listing of development goals and a description of progress towards those development goals. The development goals may be generated by the applicant and/or generated by competency correlation system 106 based on the result of the competency/requirement correlations.

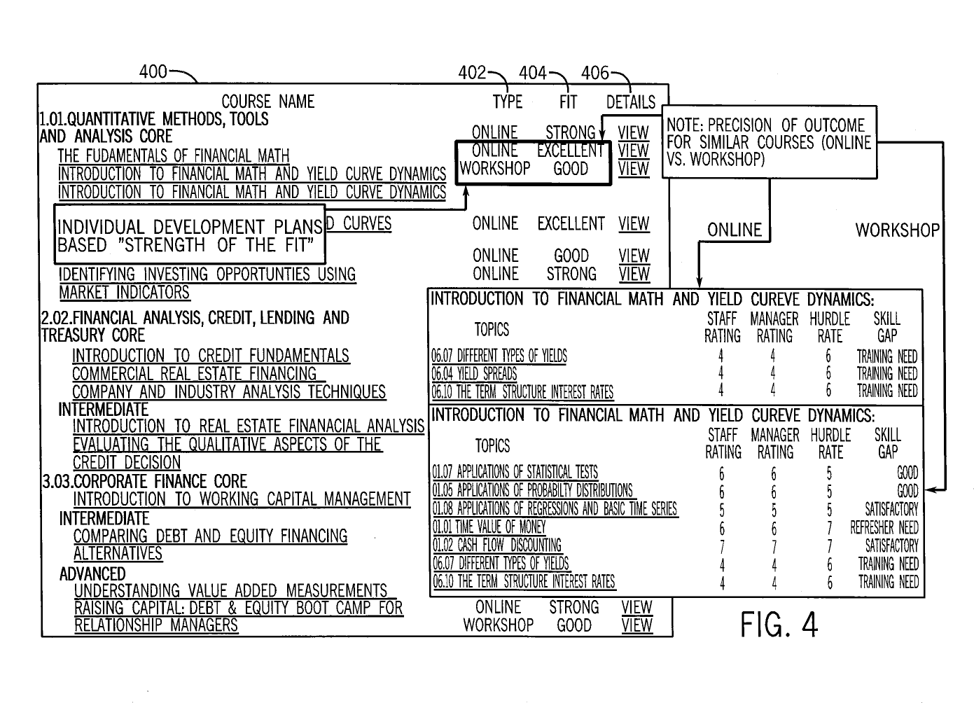

Referring now to FIG. 4, a display 400 listing of available courses, wherein each of the courses has been analyzed to determine the competencies trained by that workshop is shown, according to an exemplary embodiment. Courses may include traditional learning courses such as on line courses, in person workshops, etc. Courses may further include additional learning and/or experience providing events, such as reading training materials, having meetings with key personnel, attending social events, etc. Each course may be configured to include a listing of competencies trained by course and an indication of the degree to which the course targets the particular competency

Display 400 may be displayed based on selection of the workshops tab 304 and/or e-learning tab 306. According to an exemplary embodiment, training/reporting system 108 may be configured to determine a correlation between the competencies trained by each listed course and the competencies of an applicant that need additional training to fit one or more job requirements. Accordingly, listing 400 may be configured to include a generated fit rating 404 indicating how suitable each course is for training the competencies of the applicant indicated as requiring additional training. Listing 400 may further include a type indication 402, indicating the type of course and a details link 406 providing access to additional information for each of the courses in listing 400.

Although systems 102-108 are shown and described herein as being implemented and performed by separate computing systems, the systems may be implemented in a single computing system or in a distributed manner on multiple computing systems to perform the functions described herein. Further, the functions described herein as being performed by any system may alternatively be performed by any other system.

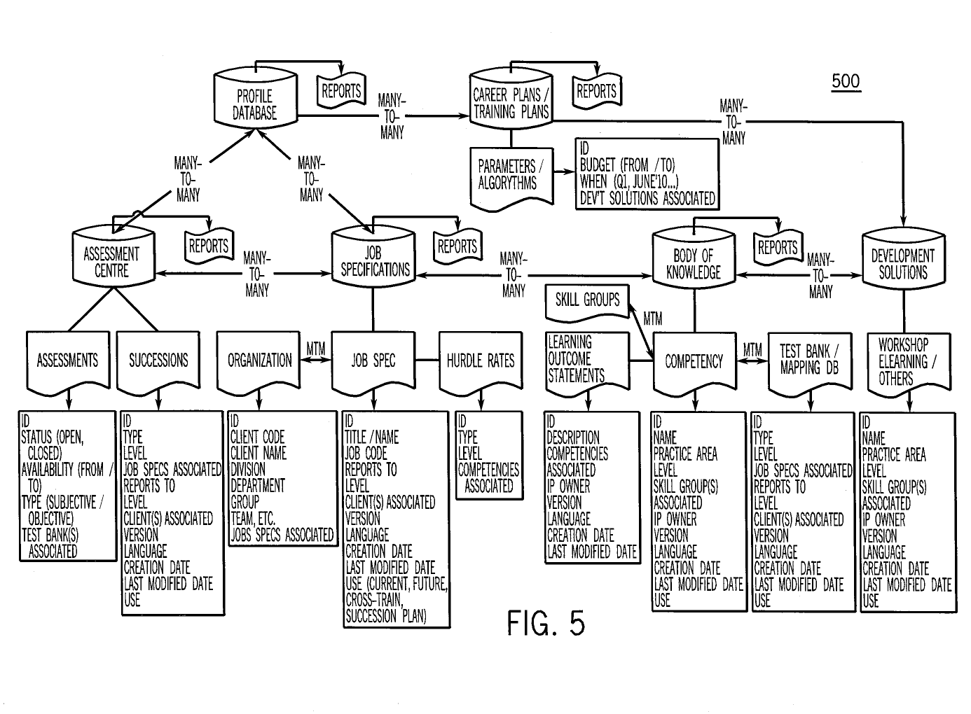

Referring now to FIG. 5, a database representation 500 illustrating the information storage and interconnection utilized by system 102-108 in implementing the functionality described herein is shown, according to an exemplary embodiment. Database 500 may be implemented using one or more standard database enabling the storage, indexing, and retrieval of stored information. Database 500 may be implemented using a single database, multiple databases, data from one or more external sources, etc. to provide the underlying data for the functions implemented by system 100.

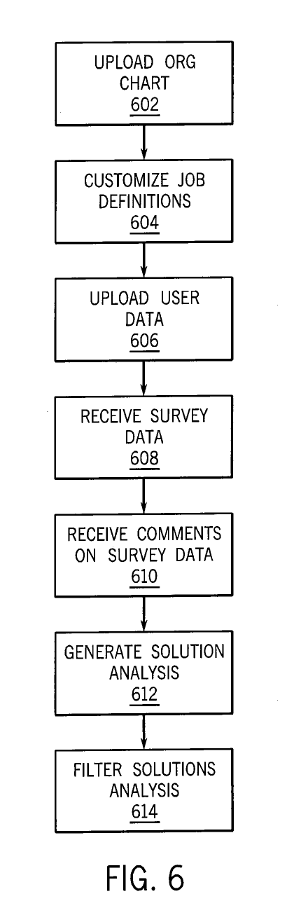

Referring now to FIG. 6, a flowchart 600 illustrating a method for implementing system 100 is shown, according to an exemplary embodiment. The steps may be implemented by one or more of systems 102-108 as described above. Although specific steps are shown and described in flowchart 600, is should be understood that the method may be performed using more, less, and/or a different ordering of steps to achieve the functionality described herein. The steps of flowchart 600 may be used to evaluate each job to be performed to determine the knowledge, skill set, and behaviors that are required or ideal for performing the job in question, to assess applicants to determine each applicant's ability to excel in that job, and to generate a correlation score indicating how well an applicant matches a job.

In a step 602, system 100 is configured to upload an organization chart to system 104. System 104, upon receiving the organization chart may be configured to generate a job definition for every entry in the organization chart. Each job definition may be configured to include knowledge, skill and behavioral requirements as well as additional information such as job level, divisions, departments, job specifications, etc. According to an exemplary embodiment, system 104 may be configured to automatically populate one or more fields of a job definition based on the values received for any other field of the job definition. For example, a job definition having a job title of security broker in an organization chart may automatically populate job requirement fields requiring competency in net present values and internal rates of return, time value of money, zero coupon rates and PV factors, basics of financial modeling, etc.

Following creation of the job definitions in step 602, system 104 may provide a user interface (not shown) to allow customization of the generated job definitions in a step 604. Customization may include adding additional job definitions, defining and/or modifying requirements for each job definition, etc. Customization may also include the addition of additional requirements that are unique to the organization.

After the job definitions have been created, system 102 may be configured to generate competency assessments for personnel. The personnel may be current employees, applicants, employees seeking transfers/promotions, etc. In a step 606, user data may be uploaded to system 102. Uploading user data may include identifying the users, listing their current and/or applied for jobs, etc.

In a step 608, system 102 is configured to receive survey data for the users uploaded in step 606. The survey data may include a self-assessment rating from each user indicating their perceived competencies for each of the job requirements identified in step 604. Following the self-assessment, one or more managers, peers, direct reports, etc. may be provided with an interface to system 102 to allow them to provide feedback on the ratings in a step 610. The competencies may be organized into knowledge, skill and behavior based competencies.

In a step 612, competency correlation system 106 is configured to generate a solutions analysis indicating a correlation between a user's competencies and the requirements of a current or sought after job definition requirements. In a step 614, system 100 is configured to identify one or more competencies that do not meet the job requirements and to generate a listing of courses selected based on a competency training profile for each course. In step 614, the listing of courses may be filtered based on one or more criteria, such as budget constraints, availability timelines, etc.

It is specifically intended that the present invention not be limited to the embodiments and illustrations contained herein, but include modified forms of those embodiments including portions of the embodiments and combinations of elements of different embodiments as come within the scope of the following claims.

We claim:

1. A computer-implemented method for identifying requirements associated with a job type and to matching personnel to the requirements including identifying any deficiencies in satisfying the requirements, comprising:
identifying one or more of each of a knowledge requirement, a skill requirement, and a behavior requirement associated with a job type;
generating and administering a competency identification test for the job type based on the requirements;
generating a personnel profile based on the competency identification test, the personnel profile including at least a knowledge competency, a skill competency and a behavior competency; and
generating a role analysis report including a correlation score indicating the determined correlation between the competencies and the requirements.

2. The method of claim 1, further including identifying one or more deficiencies in correlating competencies and requirements.

3. The method of claim 2, further including identifying one or more training requirements based on the identified one or more deficiencies.

4. The method of claim 3, wherein identifying one or more training requirements includes providing a course listing including at least one of a training course, an online workshop, a learning material, and an experience event, wherein each course in the course listing includes an indication of the competencies trained by the course and the degree to which the course trains the competency.

5. The method of claim 2, wherein correlation score includes a separate score for each identified requirement.

6. The method of claim 5, wherein the correlation score includes an aggregate score based on a determination of how many identified requirements are satisfied by the identified requirements.

7. The method of claim 5, wherein the correlation score includes a color coded indication indicating the relative correlation between the requirements and the competencies.

8. A computer-implemented system for identifying requirements associated with a job type and to matching personnel to the requirements including identifying any deficiencies in satisfying the requirements, comprising:
a computer implemented applicant assessment testing system configured to perform the steps of
receiving an identification of one or more of each of a knowledge requirement, a skill requirement, and a behavior requirement associated with a job type,
generating and administering a competency identification test for the job type based on the requirements, and
generating a personnel profile based on the competency identification test, the personnel profile including at least a knowledge competency, a skill competency and a behavior competency; and
a competency correlation system configured to generate a role analysis report including a correlation score indicating the determined correlation between the competencies and the requirements.

9. The system of claim 8, further including a computer-implemented competency training system configured to identify one or more deficiencies in correlating competencies and requirements.

10. The system of claim 9, wherein the computer-implemented competency training system is further configured to provide one or more training requirements based on the identified one or more deficiencies.

11. The system of claim 10, wherein identifying one or more training requirements includes providing a course listing including at least one of a training course, an online workshop, a learning material, and an experience event, wherein each course in the course listing includes an indication of the competencies trained by the course and the degree to which the course trains the competency.

12. The system of claim 9, wherein correlation score includes a separate score for each identified requirement.

13. The system of claim 12, wherein the correlation score includes an aggregate score based on a determination of how many identified requirements are satisfied by the identified requirements.

14. The system of claim 12, wherein the correlation score includes a color coded indication indicating the relative correlation between the requirements and the competencies.

15. A computer-implemented method for identifying one or more training workshops based on a correlation between job requirements and applicant proficiencies, comprising:
determining a listing of competencies representing knowledge, skills, or behaviors for a company, the competencies including both industry specific competencies and company specific competencies;
determining a listing of requirements for one or more jobs in the company, the requirements including both industry requirements and company specific requirements;
administering a competency identification test for at least one employee of the company;
generating an employee profile based on the competency identification test, the personnel profile including at least a knowledge competency, a skill competency and a behavior competency; and
identifying one or more jobs having requirements correlated to the competencies in the employee profile.

16. The method of claim 15, further including identifying one or more jobs where the competencies in the employee are deficient in satisfying the job requirements and generating a course listing based on the deficiency.

17. The method of claim 16, wherein the course listing includes at least one of a training course, an online workshop, a learning material, and an experience event.

18. The method of claim 17, wherein each course in the course listing includes an indication of the competencies trained by the course and the degree to which the course trains the competency.

19. The method of claim 15, further including providing a correlation score indicating the correlation between employee competencies and requirements for a plurality of the jobs in the company, the correlation score including a separate score for each identified requirement for each job.

20. The method of claim 19, wherein the correlation score includes an aggregate score based on a determination of how many identified requirements are satisfied by the identified requirements.
